(19) United States
(12) Patent Application Publication
(10) Pub. No.: US 2010/0191420 A1
(43) Pub. Date: Jul. 29, 2010

(54) DAMPING FORCE CONTROL APPARATUS FOR VEHICLE

(76) Inventors: Motohiko Honma, Aichi-ken (JP); Yuichi Mizuta, Shizuoka-ken (JP); Taisuke Hayashi, Aichi-ken (JP); Wataru Tanaka, Aichi-ken (JP)

Correspondence Address: GIFFORD, KRASS, SPRINKLE,ANDERSON & CITKOWSKI, P.C, PO BOX 7021, TROY, MI, 48007-7021, US

(21) Appl. No.: 12/669,060

(22) PCT Filed: Sep. 19, 2008
(86) PCT No.: PCT/JP2008/067583

§ 371 Date: Jan. 14, 2010

(30) Foreign Application Priority Data
Sep. 21, 2007 (JP) 2007-245979

(51) Int. Cl. B60G 17/016

(52) U.S. Cl. 701/38

(57) ABSTRACT

A damping force control apparatus for a vehicle computes an actual roll angle Φ and an actual pitch angle θ in step S11, and computes a difference Δθ between a target pitch angle θa and the actual pitch angle θ in step S12. In step 13, the apparatus computes a total demanded damping force F which must be cooperatively generated by shock absorbers so as to decrease the computed Δθ to zero. In step S14, the apparatus distributes the total demanded damping force F in proportion to the magnitude of a lateral acceleration G such that a demanded damping force Fi on the turn-locus inner side becomes greater than a demanded damping force Fo on the turn-locus outer side. In step S15, the apparatus controls the damping force of each of the shock absorbers to the damping force Fi or the damping force Fo. Thus, throughout a turn, a posture changing behavior in which the turn-locus inner side serves as a fulcrum can be maintained.

### TECHNICAL FIELD

The present invention relates to a damping force control apparatus for a vehicle which changes and controls damping forces of shock absorbers disposed between the vehicle body and wheels.

### BACKGROUND ART

There have actively been proposed apparatuses and methods which change and control damping forces of shock absorbers disposed between the vehicle body and wheels. For example, Japanese Patent Application Laid-Open (kokai) No. 2007-8373 (Patent Document 1) discloses a suspension-characteristic computation method which provides a design index of a suspension in consideration of the correlation between roll and pitch generated in the vehicle body. In this suspension-characteristic computation method, a pitch moment determined by the geometries of suspensions is computed as the sum of a front-wheel-side ascending/descending force and a rear-wheel-side ascending/descending force. The front-wheel-side ascending/descending force is represented by the product of a front-wheel-side geometry proportional coefficient and the square of a tire lateral force. The rear-wheel-side ascending/descending force is represented by the product of a rear-wheel-side geometry proportional coefficient and the square of a tire lateral force. Further, a pitch moment determined by damping forces of the suspensions is computed from the product of a damping force proportional coefficient and a roll rate. A pitch angle is then computed from the sum of the two calculated pitch moments and the product of the gain and phase delay of the pitch angle in relation to the pitch moment, and a phase difference between the pitch angle and the roll angle is computed on the basis of this computed pitch angle.

In the case where suspensions are designed in accordance with such a suspension-characteristic computation method, the timings of generations of a roll and a pitch can be synchronized through proper setting of an expansion difference and a contraction difference between shock absorbers disposed on the front wheel side and shock absorbers disposed on the rear wheel side. As a result, maneuvering stability can be improved.

Further, Japanese Patent Application Laid-Open (kokai) No. H06-99714 (Patent Document 2) discloses a vehicle suspension apparatus which can perform active roll suppression control in accordance with the roll direction of the vehicle body by use of only a steering sensor. In this vehicle suspension apparatus, when a steering angle detected by the steering sensor exceeds a predetermined neutral threshold, control is switched into a roll control mode for controlling left and right shock absorbers to have large damping forces during expansion or contraction thereof, on the basis of the roll direction of the vehicle body determined from the polarity of a steering angular speed. For a reverse steering performed thereafter, the apparatus controls the damping forces of the left and right shock absorbers such that their damping forces change in a direction opposite the direction in which the damping forces are changed in the above-described roll control mode, when the polarity of the steering angular velocity reverses.

Further, Japanese Patent Application Laid-Open (kokai) No. H06-48147 (Patent Document 3) discloses a vehicle suspension apparatus which suppresses roll stemming from abrupt steering, and prevents riding quality from deteriorating when a steering operation is performed. In this vehicle suspension apparatus, a control signal is calculated from a bounce rate based on sprung-portion ascending/descending speed, a pith rate detected from a difference of sprung-portion ascending/descending speed between the front and rear sides of the vehicle body, and a roll rate detected from a difference of sprung-portion ascending/descending speed between the left and right sides of the vehicle body. When the control signal is equal to or greater than a predetermined large threshold, the damping forces of shock absorbers on the expansion side (the side corresponding to the steering direction) are increased, and the damping forces of shock absorbers on the contraction side (the side opposite the side corresponding to a steering direction) are decreased. Further, when the control signal is equal to or less than a predetermined small threshold, the damping forces of shock absorbers on the expansion side are decreased, and the damping forces of shock absorbers on the contraction side are increased.

### DISCLOSURE OF THE INVENTION

Incidentally, it is generally said that, in order to secure maneuvering stability during turning of the vehicle, the timing of generation of a roll and that of a pitch are desired to be synchronized, as taught in Patent Document 1. Further, it is said that the vehicle is desired to have a pitch angle such that the front of the vehicle slightly descends. Moreover, in general, when a vehicle turns, as taught in Patent Documents 2 and 3, damping forces of shock absorbers disposed on the inner side of a turning locus of the center of the vehicle (hereinafter simply referred to as the “turn-locus inner side”) are increased, and damping forces of shock absorbers disposed on the outer side of the turning locus (hereinafter simply referred to as the “turn-locus outer side”) are decreased, whereby the posture of the vehicle is controlled so as to lower a sprung portion (the vehicle body).

However, when the shock-absorber damping force control as disclosed in Patent Documents 2 and 3 is performed in order to synchronize the generation timings of a roll and a pitch as disclosed in Patent Document 1, the pitch angle of the vehicle body may possibly increase after completion of a turn. That is, according to the controls disclosed in Patent Documents 2 and 3, when as shown in FIGS. 9 A to 9E a vehicle traveling straight (a state shown in FIG. 9A) starts a leftward turn in accordance with a counterclockwise rotation of a steering wheel by a driver, as shown in FIG. 9B, the damping forces of shock absorbers disposed on the turn-locus inner side (left side) are increased, and the damping forces of shock absorbers disposed on the turn-locus outer side (right side) are decreased. Therefore, the shock absorbers disposed on the turn-locus inner side (left side) function as a fulcrum, and the right side of the sprung portion (the vehicle body) descends; i.e., a clockwise roll is generated.

When the driver stops the counterclockwise steering and starts returning the steering wheel in the clockwise direction, the polarity of steering angle velocity reverses. In such a case, as shown in FIG. 9C, the damping forces of the shock absorbers disposed on the turn-locus inner side (left side) are decreased, and the damping forces of the shock absorbers disposed on the turn-locus outer side (right side) are increased. That is, in the state shown in FIG. 9C, the damping forces of the left and right shock absorbers are control as if a rightward turn were started. Therefore, despite the fact that the vehicle is still in a leftward turn state, as shown in FIG. 9D, the shock absorbers disposed on the turn-locus outer side (right side) function as a fulcrum, and a counterclockwise roll is generated in the vehicle body.

When the vehicle returns from the state where the counterclockwise roll is generated to a straight-traveling state as shown in FIG. 9E, each shock absorber is virtually brought into a contracted state. As a result, a pitch angle is generated such that the front of the vehicle body descends further. This phenomenon is considered to occur due to a difference in the roll state before and after the vehicle turn (between the roll states of FIG. 9B and FIG. 9D); in other words, due to a difference in phase between the roll angle and the pitch angle during the turn.

Further, when the turn direction of the vehicle changes or the turning state of the vehicle converges, inertia is acting on the sprung portion (the vehicle body), an unnecessary vibration may possibly be generated in the vehicle body. The generated vibration may influence the control of roll during the turn of the vehicle. Therefore, it is desired to properly damp the vibration.

The present invention has been achieved to solve the above problems, and an object of the invention is to provide a damping force control apparatus for a vehicle which can make constant the posture changing behavior of the vehicle during a turn.

In order to achieve the above-described object, the present invention provides a damping force control apparatus for a vehicle which changes and controls damping forces of shock absorbers disposed between a vehicle body and wheels. The damping force control apparatus comprises: physical quantity detection means for detecting a predetermined physical quantity which changes with turning of the vehicle; damping-force determination means for determining damping forces of shock absorbers disposed on a turn-locus inner side and damping forces of shock absorbers disposed on a turn-locus outer side in accordance with the detected predetermined physical quantity such that the damping forces of the shock absorbers disposed on the turn-locus inner side become greater than the damping forces of the shock absorbers disposed on the turn-locus outer side; and damping-force control means for changing and controlling the damping forces of the shock absorbers on the basis of the determined damping forces of the shock absorbers disposed on the turn-locus inner side and the determined damping forces of the shock absorbers disposed on the turn-locus outer side.

In this case, preferably, the predetermined physical quantity detected by the physical quantity detection means is at least one of a lateral acceleration generated as a result of turning of the vehicle, a yaw rate generated as a result of turning of the vehicle, and an operation amount of a steering wheel operated by a driver. Preferably, each shock absorber includes an electrical actuator which is electrically operated and controlled so as to change the damping force of the shock absorber, and the damping force control means electrically operates and controls the electrical actuators of the shock absorbers such that the damping forces of the shock absorbers disposed on the turn-locus inner side become greater than the damping forces of the shock absorbers disposed on the turn-locus outer side.

In this case, preferably, the damping-force determination means comprises total-damping-force calculation means for calculating a total damping force which must be cooperatively generated by left and right shock absorbers disposed on the front-wheel side of the vehicle and left and right shock absorbers disposed on the rear-wheel side of the vehicle so as to control a roll generated in the vehicle body as a result of turning of the vehicle; and total-damping-force distribution means for distributing the calculated total damping force to the shock absorbers disposed on the turn-locus inner side and the shock absorbers disposed on the turn-locus outer side in accordance with the detected predetermined physical quantity such that the damping forces of the shock absorbers disposed on the turn-locus inner side become greater than the damping forces of the shock absorbers disposed on the turn-locus outer side.

Preferably, the total-damping-force calculation means computes an actual roll angle and an actual pitch angle generated in the vehicle body, determines a target pitch angle corresponding to the computed actual roll angle on the basis of a previously set correlation between roll angle and pitch angle, computes a difference between the determined target pitch angle and the computed actual pitch angle, and calculates the total damping force such that the computed difference become about zero in order to control the roll generated in the vehicle body while synchronizing the phases of the actual roll angle and the actual pitch angle.

By virtue of the above configuration, in order to control the roll generated when the vehicle turns while synchronizing the phases of the actual roll angle and the actual pitch angle of the vehicle body, the damping forces of the shock absorbers disposed on the turn-locus inner side and the damping forces of the shock absorbers disposed on the turn-locus outer side can be controlled such that the former damping forces are greater than the latter damping forces, in accordance with the magnitude of the predetermined physical quantity (lateral acceleration, yaw rate, operation amount of the steering wheel, etc.), which changes with turning of the vehicle.

More specifically, the damping-force determination means can calculate the total damping force which must be cooperatively generated by left and right shock absorbers disposed on the front-wheel side and the rear-wheel side, respectively, of the vehicle so as to control the roll. Further, the damping-force determination means can distribute the calculated total damping force to the shock absorbers disposed on the turn-locus inner side and the shock absorbers disposed on the turn-locus outer side in accordance with the predetermined physical quantity such that the former damping forces become greater than the latter damping forces.

As described above, once the damping-force determination means determines the damping forces of the shock absorbers disposed on the turn-locus inner side and the damping forces of the shock absorbers disposed on the turn-locus outer side, the damping-force control means can electrically control the electrical actuators provided in the shock absorbers. Thus, the shock absorbers disposed on the turn-locus inner side and the shock absorbers disposed on the turn-locus outer side can generate the determined damping forces, respectively.

In the vehicle which turns in the same direction, since the acting direction of the predetermined physical quantity (specifically, the direction in which a lateral acceleration or a yaw rate generates, or the operation direction of the steering wheel) is always the same direction throughout the turn, the roll can be always controlled with the shock absorbers on the turn-locus inner side being used as a fulcrum. Accordingly, the manner of generation of the roll generated in the vehicle body in a turning state can be made consistent; in other words, the phase relation between the roll angle and the pitch angle can be made substantially constant, whereby the posture changing behavior of the vehicle during a turn can be made constant. Since the posture changing behavior of the vehicle during a turn is made constant, the roll can be controlled properly (more naturally), and the maneuvering stability of the vehicle can be improved greatly.

Preferably, the total-damping-force distribution means distributes the calculated total damping force in proportion to the detected predetermined physical quantity such that the damping forces of the shock absorbers disposed on the turn-locus inner side become greater than the damping forces of the shock absorbers disposed on the turn-locus outer side.

In this case, more preferably, the total-damping-force distribution means equally distributes the calculated total damping force to the shock absorbers disposed on the turn-locus inner side and the shock absorbers disposed on the turn-locus outer side, adds a damping force distribution amount, which is proportional to the detected predetermined physical quantity, to the damping force distributed to the shock absorbers disposed on the turn-locus inner side, and subtracts the damping force distribution amount from the damping force distributed to the shock absorbers disposed on the turn-locus outer side, such that that the damping forces of the shock absorbers disposed on the turn-locus inner side become greater than the damping forces of the shock absorbers disposed on the turn-locus outer side.

By virtue of the above configurations, the total damping forth required to control the roll can be divided into the damping forces of the shock absorbers disposed on the turn-locus inner side and the damping forces of the shock absorbers disposed on the turn-locus outer side in proportion to the magnitude of the predetermined physical quantity. This control can be performed as follows. A distribution amount which is proportional to the magnitude of the predetermined physical quantity is calculated, and the calculated distribution amount is added to the damping force of the shock absorbers disposed on the turn-locus inner side and is subtracted from the damping force of the shock absorbers disposed on the turn-locus outer side such that that the damping forces of the shock absorbers disposed on the turn-locus inner side become greater than the damping forces of the shock absorbers disposed on the turn-locus outer side.

By virtue of the above configuration, the damping forces to be generated by the shock absorbers disposed on the turn-locus inner side and the shock absorbers disposed on the turn-locus outer side, respectively, can be determined considerably exactly. Further, through addition and subtraction of the distribution amount which is proportional to the magnitude of the predetermined physical quantity, it becomes possible to maintain a state in which the damping forces of the shock absorbers disposed on the turn-locus inner side are greater than the damping forces of the shock absorbers disposed on the turn-locus outer side, while generating the total demanded damping force which is demanded for the left and right absorbers disposed on the front wheel side in order to control the roll. Accordingly, the roll can be controlled more accurately by making constant the posture changing behavior of the vehicle during a turn, whereby the maneuvering stability of the vehicle can be improved greatly.

Preferably, the damping forces of the left and right shock absorbers disposed on the front-wheel side and the rear-wheel side, respectively, are changed stepwise among a plurality of changeover steps each of which is designated by a changeover step number and which have a predetermined change amount between adjacent steps; the total-damping-force distribution means distributes the calculated total damping force to the shock absorbers disposed on the turn-locus inner side and the shock absorbers disposed on the turn-locus outer side in accordance with the detected predetermined physical quantity, by designating the changeover step number for each of the shock absorbers, such that the damping forces of the shock absorbers disposed on the turn-locus inner side become greater than the damping forces of the shock absorbers disposed on the turn-locus outer side.

In this case, preferably, the change amount of damping force between adjacent changeover steps determined for the shock absorbers disposed on the turn-locus inner side is large in relation to a change in the detected predetermined physical quantity, and the change amount of damping force between adjacent changeover steps determined for the shock absorbers disposed on the turn-locus outer side is small in relation to a change in the detected predetermined physical quantity. Further, the changeover step number may be determined linearly or non-linearly in relation to a change in the detected predetermined physical quantity.

By virtue of the above configurations, by determining the changeover step number of each shock absorber in accordance with the predetermined physical quantity, the damping forces of the shock absorber disposed on the turn-locus inner side can be made greater than the damping forces of the shock absorber disposed on the turn-locus outer side. Thus, the logic of distribution of the total demanded damping force to the shock absorbers disposed on the turn-locus inner side and outer side, respectively, can be simplified. Therefore, the computation load of the total-damping-force distribution means, which is formed of, for example, a microcomputer, can be reduced greatly.

As a result, the heat generation of the total-damping-force distribution means associated with the computation can be suppressed greatly, and cooling means or the like is not required to be provided, so that the size of the total-damping-force distribution means can be reduced. Moreover, since the logic can be simplified, even in a case where the damping force control apparatus is installed in a vehicle of a different model, a number of portions (contents of processing) which must be modified for the installation can be reduced. Accordingly, the damping force control apparatus can be readily expanded to a large number of vehicle models.

According to another feature of the present invention, the damping force control apparatus for a vehicle further comprises motion state judging means for judging a reverse of the turning direction of the vehicle or a transition of the vehicle from a turning state to a straight traveling state on the basis of the detected predetermined physical quantity; and damping-force holding means for holding the damping forces of the shock absorbers disposed on the turn-locus inner side and the damping forces of the shock absorbers disposed on the turn-locus outer side at respective predetermined levels for a predetermined time, when the motion state judging means judges a reverse of the turning direction of the vehicle or a transition of the vehicle from a turning state to a straight traveling state.

In this case, preferably, the damping-force holding means holds the damping forces of the shock absorbers disposed on the turn-locus inner side and the damping forces of the shock absorbers disposed on the turn-locus outer side at the same level for the predetermined time, when the motion state judging means judges a reverse of the turning direction of the vehicle or a transition of the vehicle from a turning state to a straight traveling state.

Preferably, the damping forces of the shock absorbers disposed on the turn-locus inner side and the damping forces of the shock absorbers disposed on the turn-locus outer side are changed stepwise among a plurality of changeover steps each of which is designated by a changeover step number and which have a predetermined change amount between adjacent steps; and the damping-force holding means holds, for the predetermined time, the damping forces of the shock absorbers disposed on the turn-locus inner side and the damping forces of the shock absorbers disposed on the turn-locus outer side at the same level by designating the same changeover step number for the shock absorbers disposed on the turn-locus inner side and outer side, respectively, when the motion state judging means judges a reverse of the turning direction of the vehicle or a transition of the vehicle from a turning state to a straight traveling state.

In this case, preferably, the motion state judging means determines changes in the motion state of the vehicle on the basis of a first judgment condition which relates to a change in the predetermined physical quantity and which is previously set in order to judge a reverse of the turning direction of the vehicle, and a second judgment condition which relates to a change in the predetermined physical quantity and which is previously set in order to judge a transition of the vehicle from a turning state to a straight traveling state.

By virtue of the above configurations, in a state in which the turning direction of the vehicle is reversed between leftward and rightward (e.g., in a S-curve travel) or in a transition from a turning state to a straight traveling state, the damping forces of the shock absorbers disposed on the turn-locus inner side and the damping forces of the shock absorbers disposed on the turn-locus outer side can be held at respective predetermined levels (more preferably, at the same level). Thus, a roll back generated in the vehicle body in the above-described states can be effectively suppressed, and a satisfactory vibration damping performance can be secured.

That is, as described above, the magnitudes of the damping forces of the shock absorbers disposed on the turn-locus inner side and the magnitudes of the damping forces of the shock absorbers disposed on the turn-locus outer side are determined in accordance with the predetermined physical quantity which changes with turning of the vehicle. However, in a state in which the turning direction of the vehicle is reversed between leftward and rightward or in a transition from a turning state to a straight traveling state, the predetermined physical quantity (lateral acceleration, yaw rate, operation amount of the steering wheel, etc.) becomes generally “0,” so that the damping forces required for the shock absorbers become very small. Meanwhile, in the above-described states, inertia acts on the sprung portion (the vehicle body), and, when the turning direction of the vehicle is reversed, the inertia acting on the sprung portion (the vehicle body) becomes the maximum.

In contrast, according to the present invention, in a state in which the turning direction of the vehicle is reversed between leftward and rightward or in a transition from a turning state to a straight traveling state, the damping forces of the shock absorbers disposed on the turn-locus inner side and the damping forces of the shock absorbers disposed on the turn-locus outer side are held at relatively large levels for a predetermined time. Thus, a roll back generated in the vehicle body due to the effect of inertia can be effectively suppressed. Accordingly, the posture changing behavior during the turning of the vehicle can be effectively prevented from becoming instable, and, for example, the roll can be controlled well.

Further, a reverse of the turning direction of the vehicle is judged on the basis of the first judgment condition, and a transition of the vehicle from a turning state to a straight traveling state is judged on the basis of the second judgment condition. Therefore, a fast rolling back and a slow rolling back (in other words, a fast rolling and a slow rolling), which depend on the above-described effect of inertia can be determined properly.

That is, in a state in which the turning direction of the vehicle is reversed, the inertia acting on the vehicle becomes the maximum, so that a fast rolling back occurs. Meanwhile, in a transition of the vehicle from a turning state to a straight traveling state, a slow (delayed) rolling back occurs due to the effect of the inertia. Since a different behavior occurs in accordance with a change in the motion state, the posture changing behavior can be effectively prevented from becoming instable, by properly determining the change in the motion state and determining the damping forces of the shock absorbers.

### BRIEF DESCRIPTION OF THE DRAWINGS

FIG. 1 is a schematic diagram showing the configuration of a damping force control apparatus for a vehicle common among embodiments of the present invention.

FIG. 2 is a flowchart of a roll control program executed by a suspension ECU of in FIG. 1.

FIG. 3 is a graph showing the relation between roll angle and pitch angle.

FIG. 4 is an explanatory view showing a method of determining a target pitch angle.

FIGS. 5A to 5E are views showing changes in the posture of a vehicle as a result of execution of the roll control program of FIG. 2.

FIG. 6 relates to a second embodiment of the present invention and is a graph showing a change in changeover step number with a change in lateral acceleration for shock absorbers on turning-locus inner and outer sides.

FIG. 7 relates to a third embodiment of the present invention and is a flowchart of a posture control program executed by the suspension ECU of in FIG. 1.

FIG. 8 is a graph showing an overshoot of pitch angle generated during turn transition.

FIGS. 9A to 9E are views showing changes in the posture of a vehicle when damping forces of shock absorbers are controlled according to the conventional damping force control.

### BEST MODE FOR CARRYING OUT THE PRESENT INVENTION

### a. First Embodiment

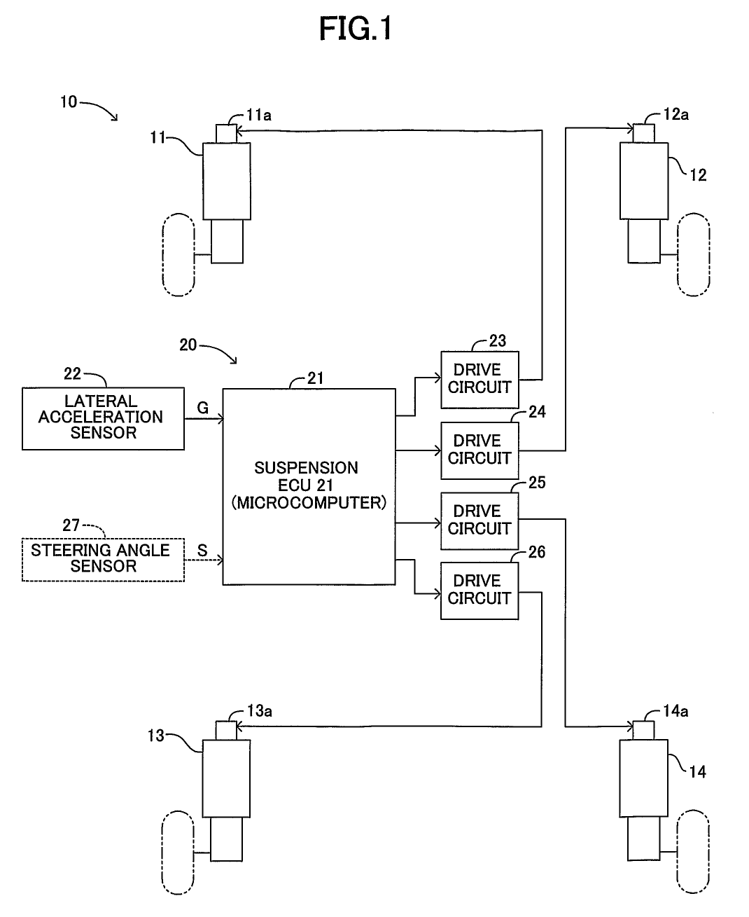

A damping force control apparatus for a vehicle (hereinafter referred to as a “vehicular damping force control apparatus”) according to an embodiment of the present embodiment will now be described in detail with reference to the drawings. FIG. 1 is a schematic diagram showing the configuration of a vehicular damping force control apparatus 10 common among embodiments of the present invention. This vehicular damping force control apparatus 10 includes shock absorbers 11, 12, 13, and 14 which connect a vehicle body and wheels (left and right front wheels and left and right rear wheels) of the vehicle.

The shock absorbers 11, 12, 13, and 14 include rotary valves (electrical actuators) 11a, 12a, 13a, and 14a, each of which changes seamlessly, for example, the diameter of a flow path for working fluid (oil, high-pressure gas, etc.). Although detailed description will be omitted, each of the rotary valves 11a, 12a, 13a, and 14a includes an unillustrated electrical drive means (e.g., an electric motor, a solenoid, or the like). An electric controller 20 electrically controls the rotary valves 11a, 12a, 13a, and 14a so as to change the diameters of the corresponding flow paths for the working fluid, to thereby seamlessly change the damping force characteristics of the shock absorbers 11, 12, 13, and 14.

The electric controller 20 includes a suspension electronic control unit 21 (hereinafter simply referred to as the “suspension ECU 21”). The suspension ECU 21 is a microcomputer which includes a CPU, ROM, RAM, etc., as main components, and which controls the damping forces of the shock absorbers 11, 12, 13, and 14 by executing various programs, including a roll control program to be described later.

A lateral acceleration sensor (physical quantity detection means) 22 for detecting lateral acceleration as a predetermined physical quantity generated in the vehicle is connected to the input side of the suspension ECU 21. The lateral acceleration sensor 22 is configured to detect a lateral acceleration G generated in the vehicle and output the detected lateral acceleration G to the suspension ECU 21. When the vehicle in a straight traveling state turns leftward (hereinafter simply referred to as making a “leftward turn”), the lateral acceleration G assumes a positive value. When the vehicle in a straight traveling state turns rightward (hereinafter simply referred to as making a “rightward turn”), the lateral acceleration G assumes a negative value.

Drive circuits 23, 24, 25, and 26 for controlling operations of the rotary valves 11a, 12a, 13a, and 14a are connected to the output side of the suspension ECU 21. This configuration enables the suspension ECU 21 to control the damping force characteristics of the shock absorbers 11, 12, 13, and 14.

Next, operation of the vehicular damping force control apparatus 10 having the above-described configuration will be described in detail.

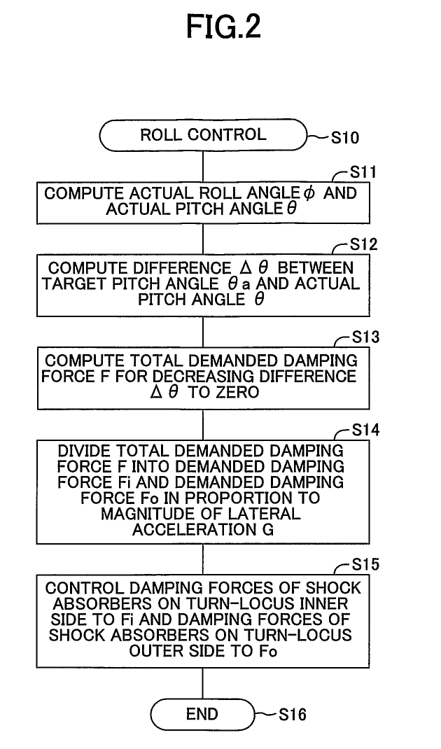

When a driver rotates an unillustrated steering wheel and the vehicle enters a turning state, the suspension ECU 21 starts execution of the roll control program shown in FIG. 2 from step S10. In step S11 subsequent thereto, the suspension ECU 21 computes an actual roll angle φ and an actual pitch angle A generated in the vehicle body. Since a computation method employed by the suspension ECU 21 so as to compute the actual roll angle φ and the actual pitch angle θ is well known, a detailed description thereof will be omitted. However, the computation method will be simply described as an example.

The actual roll angle φ can be represented by the following Eq. 1.

φ=A·sin ωt Eq. 1

where A represents a predetermined proportional constant, and ω represents the fundamental frequency of the roll angle (corresponding to, for example, the steering frequency of the steering wheel).

Since the actual pitch angle θ is generally proportional to the square of the actual roll angle φ, the actual pitch angle θ can be represented by the following Eq. 2, which uses the actual roll angle φ calculated in accordance with Eq. 1.

θ=B·φ² Eq. 2

where B represents a predetermined proportional constant.

After completion of the calculation of the actual roll angle φ and the actual pitch angle θ in accordance with Eqs. 1 and 2, the suspension ECU 21 proceeds to step S12. Needless to say, instead of calculating the actual roll angle φ and the actual pitch angle θ through the above-described computation processing or estimation computation processing, the actual roll angle φ and the actual pitch angle θ may be directly detected by use of, for example, a roll angle sensor for detecting the actual roll angle φ generated in the vehicle and a pitch angle sensor for detecting the actual pitch angle θ generated in the vehicle.

In step S12, the suspension ECU 21 calculates a difference Δθ between a target pitch angle θa and the actual pitch angle θ by reference to a target map which shows the correlation between roll angle and pitch angle determined such that the vehicle has satisfactory maneuvering stability at the time of turning. This calculation will now be described in detail.

In general, in order to improve the maneuvering stability at the time when the vehicle turns, it is said to be effective to synchronize the generation timings of a roll and a pitch generated in the vehicle body in a turning state. That is, when a vehicle which is excellent in maneuvering stability is in a turning state, a roll and a pitch tend to be simultaneously generated in the vehicle body; and when a vehicle which is poor in maneuvering stability is in a turning state, a roll and a pitch tend to be generated in the vehicle body with a time difference therebetween. This means that the greater the degree of maneuvering stability of a vehicle, the smaller the phase difference between the roll angle and the pitch angle generated in the vehicle body.

That is, in a vehicle which is excellent in maneuvering stability, the phase difference between the roll angle and the pitch angle tends to become small. This means that the pitch angle changes with a very small hysteresis in relation to a change in the roll angle. Meanwhile, in a vehicle which is poor in maneuvering stability, the phase difference between the roll angle and the pitch angle tends to become large. This means that the pitch angle changes with a large hysteresis in relation to a change in the roll angle.

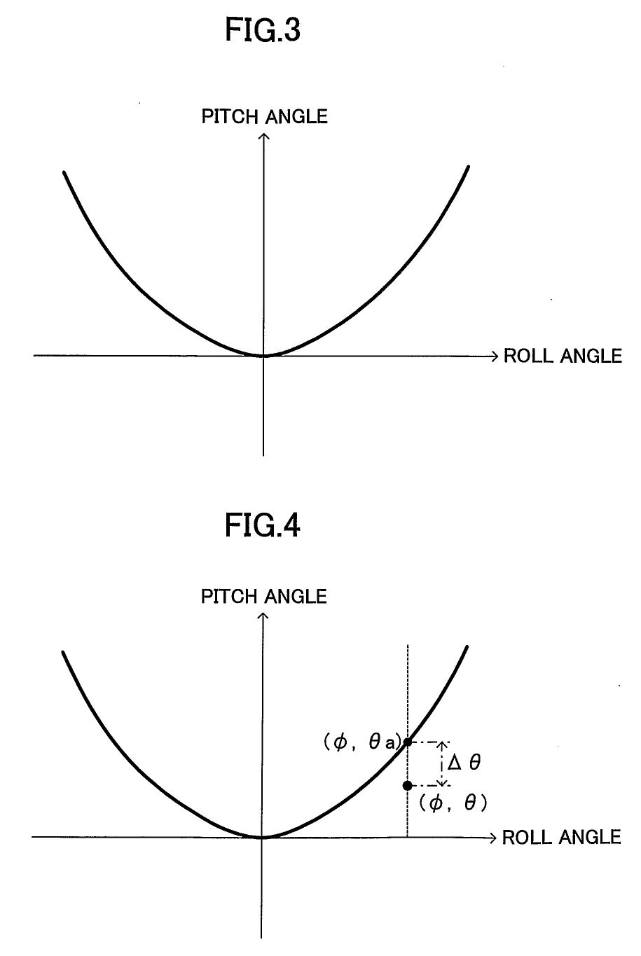

Therefore, in order to improve the maneuvering stability of the vehicle, the roll angle and the pitch angle are desired to have a correlation as shown in FIG. 3; i.e., the pitch angle changes with a very small hysteresis in relation to a change in the roll angle. Incidentally, in general, a vehicle in a turning state travels while generating a roll by descending a portion of the sprung portion (i.e., the vehicle body) on the turn-locus outer side. Accordingly, controlling the pitch angle is effective in order to attain satisfactory maneuvering stability for a change in the generated roll angle.

In this case, the suspension ECU 21 can perform roll control for securing satisfactory maneuvering stability, if the suspension ECU 21 employs, as a target map, a map representing the relation shown in FIG. 3, determines the target pitch angle θa corresponding to the actual roll angle φ generated in the vehicle body in a turning state by reference to the target map, and renders the actual pitch angle θ coincident with the target pitch angle θa. Therefore, as shown in FIG. 4, the suspension ECU 21 calculates the difference Δθ between the actual pitch angle θ and the target pitch angle θa corresponding to the actual roll angle φ. After completion of the calculation of the difference Δθ, the suspension ECU 21 proceeds to step S13.

In step S13, the suspension ECU 21 calculates a total demanded damping force F for the front-wheel-side left and right shock absorbers 11 and 12 and the rear-wheel-side left and right shock absorbers 13 and 14, which is required to reduce the difference Δθ to “0”; i.e., render the actual pitch angle θ coincident with the target pitch angle θa. Calculation of this total demanded damping force F will be described below. However, since any of various known methods can be employed for the calculation, a detailed description therefor will be omitted, and the calculation will be simply described as an example.

The pitch angle generated in the vehicle body is generated because of a pitch moment M in the longitudinal direction of the vehicle body. Therefore, the total demanded damping force F needed for controlling the pitch angle generated in the vehicle body can be calculated by use of the pitch moment M.

The pitch moment M can be calculated by the following Eq. 3.

M=I·(Δθ)″+C·(Δθ)′+K·(Δθ) Eq. 3

where I represents an inertia moment, C represents a damping coefficient, and K represents a spring constant. Further, in Eq. 3, (Δθ)″ represents the second derivative value of the difference Δθ calculated in the above-mentioned step S12, and (Δθ)′ represents the first derivative value of the difference Δθ.

The total demanded damping force F can be calculated by dividing the pitch moment M in the longitudinal direction of the vehicle body represented by Eq. 3, by a wheel base L of the vehicle. That is, the total demanded damping force F can be calculated by the following Eq. 4.

F=M/L Eq. 4

Upon completion of the calculation of the total demanded damping force F, the suspension ECU 21 proceeds to step S14.

In step S14, the suspension ECU 21 executes a distribution computation for distributing the total demanded damping force F calculated in the above-described step S13 between the front-wheel-side left and right shock absorbers 11 and 12 and between the rear-wheel-side left and right shock absorbers 13 and 14. Notably, in the following description, similar calculation is performed for both the front wheel side and the rear wheel side. Therefore, the description will be provided for the front-wheel-side left and right shock absorbers 11 and 12 only.

For distribution of the total demanded damping force F to the left and right shock absorbers 11 and 12, the suspension ECU 21 uses a distribution amount X which is proportional to the magnitude of the lateral acceleration G generated in the vehicle in a turning state. Specifically, when assuming a state where the total damping force F is required to be distributed to the front wheel side of the vehicle, first, the total demanded damping force F is equally distributed to the shock absorbers 11 and 12.

Subsequently, the suspension ECU 21 adds the distribution amount X to the demanded damping force (F/2) equally distributed to each of the shock absorbers 11 and 12. At this time, on the basis of the polarity of the lateral acceleration G received from the lateral acceleration sensor 22, the suspension ECU 21 adds the distribution amount X of the positive to the demanded damping force (F/2) of the shock absorber 11 (the shock absorber 12) on the turn-locus inner side, and adds the distribution amount X of the negative to the demanded damping force (F/2) of the shock absorber 12 (the shock absorber 11) on the turn-locus outer side.

That is, a damping force Fi demanded for the shock absorber 11 (the shock absorber 12) on the turn-locus inner side, and a damping force Fo demanded for the shock absorber 12 (the shock absorber 11) on the turn-locus outer side are represented by the following Eqs. 5 and 6.

Fi=(F/2)+X Eq. 5

Fo=(F/2)−X Eq. 6

Since the distribution amount X is proportional to the magnitude of the lateral acceleration G, it can be represented by the following Eq. 7.

X=α·(F/2) Eq. 7

where α represents a variable which changes in proportion to the magnitude of the lateral acceleration G and is represented by the following Eq. 8.

α=(1+|G|·K) Eq. 8

where K is a positive variable which may change in accordance with a mode selected by the driver for the roll control performed by the suspension ECU 21; for example, a mode selected from a control mode for giving priority to ride quality and a control mode for giving priority to sporty driving.

Incidentally, on the basis of the above-mentioned Eqs. 5 to 8, there stands a relation in which the damping force Fi demanded for the shock absorber 11 (the shock absorber 12) on the turn-locus inner side always assumes a positive value, and the damping force Fo demanded for the shock absorber 12 (the shock absorber 11) on the turn-locus outer side always assumes a negative value. Further, when the damping force Fi demanded for the shock absorber 11 (the shock absorber 12) on the turn-locus inner side and the damping force Fo demanded for the shock absorber 12 (the shock absorber 11) on the turn-locus outer side are added together, the result becomes equal to the total demanded damping force F demanded for the front wheel side. Since the damping forces required on the turn-locus inner side and the turn-locus outer side differ in polarity as described above, the shock absorbers 11 and 12 can be caused to generate proper damping forces when the vehicle turns.

That is, since the distribution amount X is calculated by use of the variable α, which changes in proportion to the lateral acceleration G, in a state in which the vehicle is turning in the same direction, the absolute value of the demanded damping force Fi of the shock absorber 11 (the shock absorber 12) on the turn-locus inner side assumes a large positive value, and the absolute value of the demanded damping force Fo of the shock absorber 12 (the shock absorber 11) on the turn-locus outer the shock assumes a small negative value.

Use of the variable α, which changes in proportion to the lateral acceleration G, enables the demanded damping forces Fi and Fo of the left and right shock absorbers 11 and 12 to be changed in accordance with the magnitude of the variable α, although the total damping force F demanded for the front wheel side does not change. Accordingly, when the vehicle turns, the shock absorbers 11 and 12 can properly generate damping forces, to thereby change the actual pitch angle θ generated in the vehicle body to the target pitch angle θa without fail.

The suspension ECU 21 proceeds to step S15 after it distributes the total demanded damping force F to the left and right shock absorbers 11, 12, 13, and 14 such that the demanded damping force Fi is distributed to the shock absorbers on the turn-locus inner side and the demanded damping force Fo is distributed to the shock absorbers on the turn-locus outer side.

In a state where the total demanded damping force F is distributed between the left and right shock absorbers, as is clear from the above-described Eqs. 5 to 8, there stands a relation in which the damping force Fi demanded for the shock absorber 11 (the shock absorber 12) on the turn-locus inner side always assumes a large value, and the damping force Fo demanded for the shock absorber 12 (the shock absorber 11) on the turn-locus outer side always assumes a small value, so long as the lateral acceleration G generated in the vehicle acts in the same direction. Thus, the actual pitch angle θ can be prevented from increasing when the vehicle returns from the turning state to the straight traveling state. This will be described in detail for the front-wheel side shock absorbers 11 and 12 under the assumption that the vehicle makes a leftward turn.

When the driver rotates the steering wheel in the counterclockwise direction in a state where the vehicle is in a straight traveling state, the vehicle in a straight traveling state enters a leftward turn state. In this case, of the shock absorbers 11 and 12, the shock absorber 11 on the left side of the vehicle is located on the turn-locus inner side, and the shock absorber 12 on the right side of the vehicle is located on the turn-locus outer side.

In this state, the suspension ECU 21 calculates the variable α in accordance with the above-mentioned Eq. 8, from the absolute value of the detected lateral acceleration G received from the lateral acceleration sensor 22, and calculates the distribution amount X in accordance with the above-mentioned Eq. 7. Further, the suspension ECU 21 calculates the demanded damping force Fi for the shock absorber 11 in accordance with the above-mentioned Eq. 5, and calculates the demanded damping force Fo for the shock absorber 12 in accordance with the above-mentioned Eq. 6.

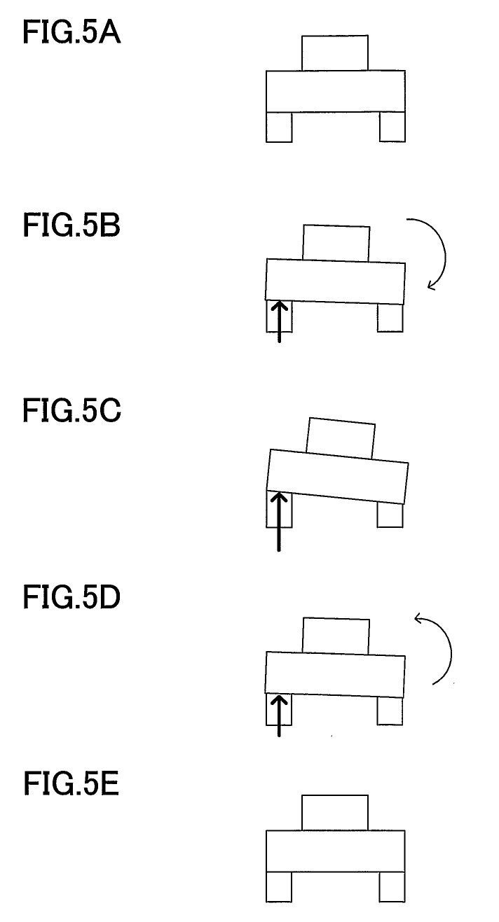

Referring to FIGS. 5A to 5E, when the vehicle starts a leftward turn from a straight traveling state shown in FIG. 5A, a lateral acceleration G is generated in the vehicle in the lateral direction. In this case, as described above, the demanded damping force Fi of the shock absorber 11 on the turn-locus inner side increases, and the demanded damping force Fo of the shock absorber 12 on the turn-locus outer side decreases. Therefore, as shown in FIG. 5B, the shock absorber 12 is contracted, and a clockwise roll is generated in the vehicle body. Further, when the turning state continues and the lateral acceleration G becomes the maximum, the demanded damping force Fi of the shock absorber 11 on the turn-locus inner side increases further, and the demanded damping force Fo of the shock absorber 12 on the turn-locus outer side decreases further. Therefore, as shown in FIG. 5C, the shock absorber 12 is contracted further, and the maximum clockwise roll is generated in the vehicle body.

When the driver rotates the steering wheel toward the neutral position; i.e., the direction for causing the vehicle to travel straight, the turning state of the vehicle changes from the state shown in FIG. 5C to a turning back state. In this turning back state, the leftward lateral acceleration G is continuously generated in the vehicle. Accordingly, even after the vehicle has entered the turning back state, the shock absorber 11 corresponds to the turn-locus inner side, and the shock absorber 12 corresponds to the turn-locus outer side. Therefore, the demanded damping force Fi is continuously demanded for the shock absorber 11, and the demanded damping force Fo is continuously demanded for the shock absorber 12.

Incidentally, in the turning back state, although the lateral acceleration G generated in the vehicle decreases, the input lateral acceleration G assumes the same value as in the state shown in FIG. 5B. Therefore, even in the turning back state, as shown in FIG. 5D, the demanded damping force Fi of the shock absorber 11 on the turn-locus inner side is large, and the demanded damping force Fo of the shock absorber 12 on the turn-locus outer side is small. In this case, an inertial force and the like act on the vehicle body, so that the actual roll angle φ generated in the vehicle body decreases. At that time, since the demanded damping force Fo of the shock absorber 12 on the turn-locus outer side is small, the vehicle body quickly moves in the direction for decreasing the actual roll angle φ to “0.”

When the driver stops the rotating operation of the steering wheel at the neutral position, the vehicle returns to the straight traveling state. At that time, in a period in which the vehicle is in the leftward turn state, the demanded damping force Fi of the shock absorber 11 on the turn-locus inner side is maintained at a large value. Therefore, as shown in FIG. 5E, the actual pitch angle θ of the vehicle having returned to the straight traveling state becomes the same as that before the vehicle entered the turning state; i.e., that in the state shown in FIG. 5A.

After completion of the division of the total demanded damping force F into the demanded damping force Fi and the demanded damping force Fo to be distributed to the left and right shock absorbers 11 and 12 (or the shock absorbers 13 and 14), in step S15, the suspension ECU 21 drives and controls the drive circuits 23, 24, 25, and 26 such that the shock absorbers on the turn-locus inner side generate the demanded damping force Fi distributed thereto in the above-mentioned step S14, and the shock absorbers on the turn-locus outer side generate the demanded damping force Fo distributed thereto in the above-mentioned step S14. As a result, the rotary valves 11a, 12a, 13a, and 14a of the shock absorbers 11, 12, 13, and 14 change the diameters of the corresponding work fluid flow paths. Accordingly, the damping forces generated by the shock absorbers 11, 12, 13, and 14 each become equal to the demanded damping force Fi or the demanded damping force Fo depending on the turn direction of the vehicle.

After having properly changed the damping forces of the shock absorbers 11, 12, 13, and 14, the suspension ECU 21 proceeds to step S16 so as to end the execution of the roll control program.

As can be understood from the above description, according to the first embodiment, in order to control the roll generated during a turn of the vehicle while synchronizing the phase difference between the actual roll angle φ the actual pitch angle θ generated in the vehicle body, the damping forces of the shock absorbers can be controlled in accordance with the magnitude of the lateral acceleration G, which changes with the turn of the vehicle, such that the demanded damping force Fi of the shock absorbers disposed on the turn-locus inner side becomes larger than the demanded damping force Fo of the shock absorbers disposed on the turn-locus outer side.

More specifically, in order to control the roll, the suspension ECU 21 can calculate the total demanded damping force F to be cooperatively generated by the left and right shock absorbers 11, 12, 13, and 14 disposed on the front side and rear side, respectively. The suspension ECU 21 can distribute the total demanded damping force F in accordance with the magnitude of the lateral acceleration G such that the demanded damping force Fi of the shock absorbers disposed on the turn-locus inner side becomes larger than the demanded damping force Fo of the shock absorbers disposed on the turn-locus outer side.

Upon determination of the demanded damping force Fi of the shock absorbers disposed on the turn-locus inner side and the demanded damping force Fo of the shock absorbers disposed on the turn-locus outer side, the suspension ECU 21 electrically controls the rotary valves 11a, 12a, 13a, and 14a provided in the shock absorbers 11, 12, 13, and 14. Thus, the shock absorbers disposed on the turn-locus inner side and the shock absorbers disposed on the turn-locus outer side can generate the determined demanded damping forces Fi and Fo, respectively.

In the vehicle which turns in the same direction, the lateral acceleration G is always generated in the same direction throughout the turn. Therefore, the above-described control enables the roll to be controlled while using the shock absorbers on the turn-locus inner side as a fulcrum. Therefore, the manner of generation of a roll in the vehicle body in a turning state can be made consistent; in other words, the phase relation between the actual roll angle φ and the actual pitch angle θ can be made substantially constant, whereby the posture changing behavior of the vehicle during a turn can be made constant. Since the posture changing behavior of the vehicle during a turn is made constant, the roll can be controlled properly (more naturally), and the maneuvering stability of the vehicle can be improved greatly.

Further, the total demanded damping force F, which is required to control the roll, can be divided into the demanded damping force Fi of the shock absorbers disposed on the turn-locus inner side and the demanded damping force Fo of the shock absorbers disposed on the turn-locus outer side in proportion to the magnitude of the lateral acceleration G. At that time, the distribution amount X, which is proportional to the magnitude of the absolute value of the lateral acceleration G, is calculated, and the calculated distribution amount X is added to the damping force of the shock absorbers disposed on the turn-locus inner side and is subtracted from the damping force of the shock absorbers disposed on the turn-locus outer side, to which the total demanded damping force F is distributed equally, whereby the damping force Fi of the shock absorbers disposed on the turn-locus inner side can be made greater than the damping force Fo of the shock absorbers disposed on the turn-locus outer side.

By virtue of the above calculation, the damping forces Fi and Fo to be generated by the shock absorbers disposed on the turn-locus inner side and the shock absorbers disposed on the turn-locus outer side, respectively, can be determined with considerable precision. Further, since the distribution amount X, which is proportional to the magnitude of the lateral acceleration G, is added or subtracted, it is possible to maintain a state in which the damping force Fi of the shock absorbers disposed on the turn-locus inner side is greater than the damping force Fo of the shock absorbers disposed on the turn-locus outer side, while generating the total demanded damping force F which is demanded for the left and right absorbers 11 and 12 disposed on the front wheel side in order to control the roll behavior. Accordingly, the roll behavior can be controlled more accurately by making constant the posture changing behavior of the vehicle during a turn, whereby the maneuvering stability of the vehicle can be improved greatly.

### b. Second Embodiment

In the above-described first embodiment, the suspension ECU 21 computes the distribution amount X, which is proportional to the lateral acceleration G generated in the vehicle, in accordance with the above-mentioned Eqs. 7 and 8, and calculates the demanded damping force Fi of the shock absorbers disposed on the turn-locus inner side and the damping force Fo of the shock absorbers disposed on the turn-locus outer side in accordance with the above-mentioned Eqs. 5 and 6. The suspension ECU 21 then continuously operates the rotary valves 11a, 12a, 13a, and 14a via the drive circuits 23, 24, 25, and 26, to thereby control the damping forces of the shock absorbers 11, 12, 13, and 14 such that the computed demanded damping force Fi and demanded damping force Fo are generated by the corresponding shock absorbers.

However, the damping forces of the shock absorbers 11, 12, 13, and 14 can be controlled in a simpler manner. A second embodiment which employs such a simpler control will now be described in detail.

In the second embodiment as well, the suspension ECU 21 changes and controls the damping forces of the shock absorbers 11, 12, 13, and 14 in accordance with the magnitude of the lateral acceleration G generated in the vehicle and detected by the lateral acceleration sensor 22. However, in the second embodiment, the suspension ECU 21 changes the damping forces of the shock absorbers 11, 12, 13, and 14 stepwise by a predetermined change amount. That is, the suspension ECU 21 determines a changeover step of each of the rotary valves 11a, 12a, 13a, and 14a, which are provided so as to change the corresponding damping forces, so as to stepwise change the diameter of the corresponding work fluid flow path, and controls the rotary valves 11a, 12a, 13a, and 14a of the shock absorbers 11, 12, 13, and 14 such that each of the rotary valves 11a, 12a, 13a, and 14a reaches the determined changeover step.

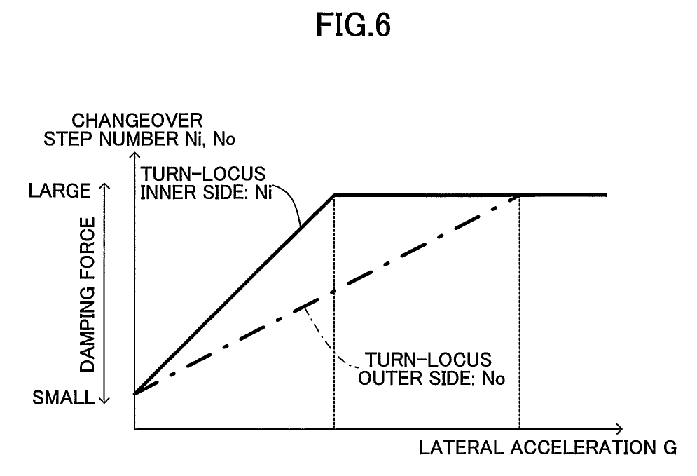

Here, the changeover step of each of the rotary valves 11a, 12a, 13a, and 14a will be described. As schematically shown in FIG. 6, there are provided a plurality of changeover steps (e.g., 9 steps). As the absolute value of the lateral acceleration G increases, the changeover step changes from a changeover step at which the damping force decreases to a changeover step at which the damping force increases. Further, the change amount or width between adjacent changeover steps is set such that the change amount for the shock absorbers on the turn-locus inner side is large, and the change amount for the shock absorbers on the turn-locus outer side is small. That is, even when the absolute value of the detected lateral acceleration G is small, the changeover step for the shock absorbers on the turn-locus inner side becomes the highest step at which the damping force becomes the maximum. In contrast, the changeover step for the shock absorbers on the turn-locus outer side becomes the highest step when the absolute value of the detected lateral acceleration G is large.

Notably, the apparatus of the second embodiment is configured such that the changeover step number changes in proportion to or linearly with a change in the detected lateral acceleration G. However, the apparatus of the second embodiment may be configured such that the changeover step number changes non-linearly with a change in the detected lateral acceleration G.

Upon reception of the lateral acceleration G detected by the lateral acceleration sensor 22, the suspension ECU 21 determines a changeover step number (demanded damping force) of each of the shock absorbers corresponding to the turn-locus inner side and outer side, respectively, by reference to a changeover step number map, as shown in FIG. 6, which shows a previously set relation between the magnitude of the lateral acceleration G and the changeover step number.

Notably, the change amount of damping force between adjacent changeover steps is determined such that the sum of the damping force generated by the shock absorbers corresponding to the turn-locus inner side at a certain changeover step (designated by a certain changeover step number) and the damping force generated by the shock absorbers corresponding to the turn-locus outer side at a corresponding changeover step becomes equal to the total demanded damping force F in the above-described first embodiment. Thus, when the changeover step number for the shock absorbers on the turn-locus inner side and the changeover step number for the shock absorbers on the turn-locus outer side are determined by the suspension ECU 21, the total demanded damping force F is distributed to the left and right absorbers in accordance with the determined changeover step numbers.

Next, the determination of the changeover step numbers for the shock absorbers 11 and 12 on the front-wheel side will be described specifically. Upon receipt of the lateral acceleration G detected by the lateral acceleration sensor 22, the suspension ECU 21 determines the turning direction of the vehicle on the basis of the polarity of the lateral acceleration G. That is, when the received lateral acceleration G is positive, the vehicle is currently in a leftward turning state. Therefore, the suspension ECU 21 determines that the shock absorber 11 corresponds to the turn-locus inner side, and the shock absorber 12 corresponds to the turn-locus outer side.

Subsequently, by reference to the changeover step number map shown in FIG. 6, the suspension ECU 21 determines a changeover step number Ni of the shock absorber 11 on the turn-locus inner side and a changeover step number No of the shock absorber 12 on the turn-locus outer side on the basis of the absolute value of the received lateral acceleration G. At that time, the changeover step number Ni of the shock absorber 11 on the turn-locus inner side is greater than the changeover step number No of the shock absorber 12 on the turn-locus outer side. In other words, the suspension ECU 21 demands a large damping force for the shock absorber 11 on the turn-locus inner side and a small damping force for the shock absorber 12 on the turn-locus outer side.

Therefore, in the second embodiment as well, in order to control the roll angle φ generated in the vehicle body, the total demanded damping force F, required to render the actual pitch angle θ coincident with the target pitch angle θa, can be properly distributed to the left and right shock absorbers 11 and 12 (or the shock absorbers 13 and 14) in accordance with the lateral acceleration G generated in the vehicle. Since the phase difference can be changed in a similar manner in both of the turning state and the turning back state, the effect similar to that attained in the first embodiment can be expected.

Further, in the second embodiment, once the detected lateral acceleration G is received from the lateral acceleration sensor 22, the suspension ECU 21 can determine the changeover step number Ni of the shock absorber 11 on the turn-locus inner side and the changeover step number No of the shock absorber 12 on the turn-locus outer side through a simple operation of referring to the changeover step number map on the basis of the received lateral acceleration G. That is, it is unnecessary to determine the demanded damping force Fi and the demanded damping force Fo through computation process as in the first embodiment. Therefore, the load of the suspension ECU 21 can be reduced, and problems, such as, heat generation due to an increase in the processing load, can be solved.

Further, since the heat generation of the suspension ECU 21 stemming from computation can be suppressed, it is unnecessary to prove cooling means or the like for the suspension ECU 21. Therefore, the size of the apparatus itself can be reduced. Moreover, the logic for distribution of the total demanded damping force F can be simplified. Therefore, even in a case where the vehicular damping force control apparatus 10 is installed in a vehicle of a different model, a number of portions (contents of processing) which must be modified for the installation can be reduced. Accordingly, the vehicular damping force control apparatus 10 can be readily expanded to a large number of vehicle models.

### c. Third Embodiment

In the first and second embodiments, in a turning state in which the lateral acceleration G is generated in the same direction, the demanded damping force Fi or the changeover step number Ni of the shock absorbers corresponding to the turn-locus inner side is determined to assume a large value, and the demanded damping force Fo or the changeover step number No of the shock absorbers corresponding to the turn-locus outer side is determined to assume a small value. Incidentally, when the vehicle repeats leftward and rightward turns as in an S-curve travel, the vehicle naturally enters a straight traveling state in a transition from a leftward (rightward) turning state to a rightward (leftward) turning state.

When the vehicle is in a straight traveling state, the lateral acceleration G detected by the lateral acceleration sensor 22 becomes “0.” Therefore, when the damping forces Fi and Fo or the changeover step numbers Ni and No are determined on the basis of the magnitude of the lateral acceleration G as having been described in the first and second embodiments, the damping forces demanded for the shock absorbers 11, 12, 13, and 14 become the minimum. Meanwhile, when the turning state changes and the vehicle enters a straight traveling state in the middle of the S-curve travel, the inertia acting on the sprung portion (i.e., the vehicle body) becomes the maximum, so that a large vibration (roll back) is generated as a result of changeover of the turning state.

In such a case, since the damping forces generated by the shock absorbers 11, 12, 13, and 14 become the minimum, there is a possibility that the generated vibration cannot be damped satisfactorily. Further, since the damping forces become the minimum, the actual pitch angle θ overshoots, whereby the vehicle may assume a so-called rearward-tilted state; i.e., a state in which the front wheel side is lifted in relation to the rear wheel side. Accordingly, the damping force controls of the first and second embodiments are desired to be modified so as to damp or suppress vibrations, in particular, in a straight traveling state. A third embodiment which can damp or suppress vibrations in a straight traveling state will now be described.

In the third embodiment, as shown by a broken line in FIG. 1, the suspension ECU 21 is connected to a steering angle sensor 27 which detects and outputs a the amount of rotation of the steering wheel (not shown) by the driver. The steering angle sensor 27 outputs, as a steering angle S, the amount of rotation from the neutral position of the steering wheel, at which the vehicle travels straight. Notably, the steering angle S output from the steering angle sensor 27 assumes a positive value when the driver rotates the steering wheel in a direction for turning the vehicle leftward, and assumes a negative value when the driver rotates the steering wheel in a direction for turning the vehicle rightward.

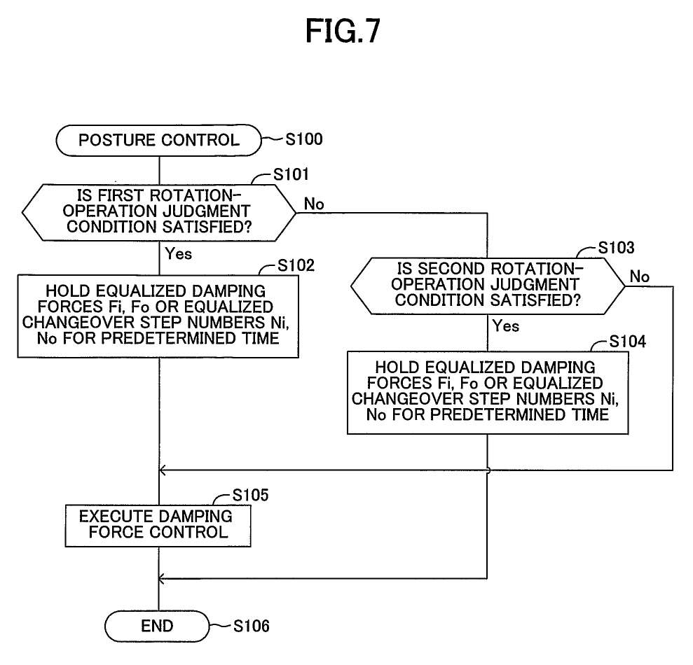

The suspension ECU 21 executes a posture control program shown in FIG. 7 when the vehicle turns. Specifically, the suspension ECU 21 starts the execution of the posture control program from step S100 at predetermined short time intervals. In step S101, the suspension ECU 21 determines whether or not the rotation operation of the steering wheel by the driver satisfies a first rotation-operation judgment condition. This determination processing will be described below.

This first rotation-operation judgment condition is a condition for judging that the vehicle enters a straight traveling state in the middle of a transition from a leftward turning state (rightward turning state) to a rightward turning state (leftward turning state) (hereinafter, this transition between the turning states will be referred to as “turning transition”). Specifically, the vehicle enters a straight traveling state or a turning state in accordance with the rotation operation of the steering wheel by the driver.

Therefore, when the vehicle is in the turning transition, the driver rotates the steering wheel while passing through the neutral position; i.e., switches the rotation direction from the counterclockwise direction (clockwise direction) to the clockwise direction (counterclockwise direction). Accordingly, when the vehicle enters a straight traveling state in the middle of the turning transition, the state of the rotation operation of the steering wheel is such that the absolute value of the steering angle S is small, and a steering angle velocity S′, which is obtained by differentiating the steering angle S with time, becomes relatively large.

In view of the above, the first rotation-operation judgment condition is determined such that the detected steering angle S is not greater than a reference steering angle Sb, and the steering angle velocity S′ is not less than a reference steering angle velocity S′b. In order to perform a determination as to whether or not the first rotation-operation judgment condition is satisfied, the suspension ECU 21 receives the steering angle S detected by the steering angle sensor 27, and calculates the steering angle velocity S′ by differentiating the steering angle S with time.

When the detected steering angle S and the steering angle velocity S′ satisfy the first rotation-operation judgment condition, the result of the determination in step S101 becomes “Yes,” and the suspension ECU 21 proceeds to step S102. Meanwhile, when the detected steering angle S and the steering angle velocity S′ do not satisfy the first rotation-operation judgment condition, the result of the determination in step S101 becomes “No,” and the suspension ECU 21 proceeds to step S103.

In step S102, the suspension ECU 21 equalizes the demanded damping forces Fi and Fo or the changeover step numbers Ni and No of the front-wheel-side left and right shock absorbers 11 and 12 and the rear-wheel-side left and right shock absorbers 13 and 14, and maintains the equalized damping forces Fi and Fo or the equalized changeover step numbers Ni and No for a predetermined time. Specifically, a state where the first rotation-operation judgment condition is satisfied in the above-described step S11 is a state where the vehicle enters a straight traveling condition in the middle of the turning transition. In this state, the roll generated in the vehicle body due to the leftward turn converges and a new roll is generated in the vehicle body for a rightward turn; i.e., the vehicle is in a transition state. Therefore, the moving speed (including that associated with inertia) in the roll direction of the vehicle body, which corresponds to the sprung portion, becomes the maximum.

Meanwhile, in a state in which the first rotation-operation judgment condition is satisfied and the vehicle travels straight, no lateral acceleration is generated, so that the lateral acceleration G detected by the lateral acceleration sensor 22 becomes “0.” Therefore, when the damping forces Fi and Fo or the changeover step numbers Ni and No are determined in accordance with the lateral acceleration G as having been described in the first and second embodiments, the damping forces generated by the shock absorbers 11, 12, 13, and 14 become extremely small.

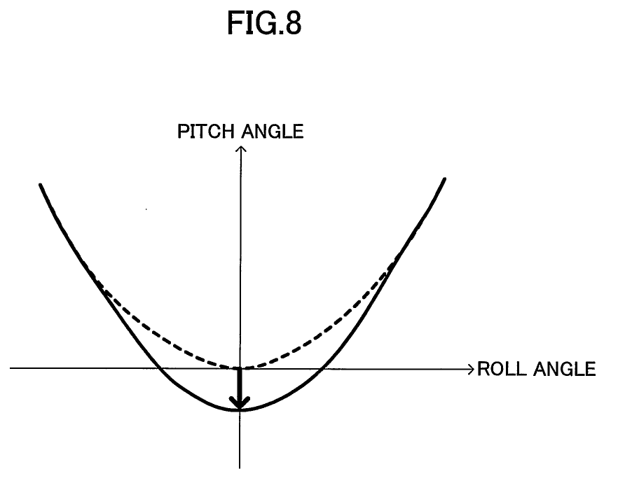

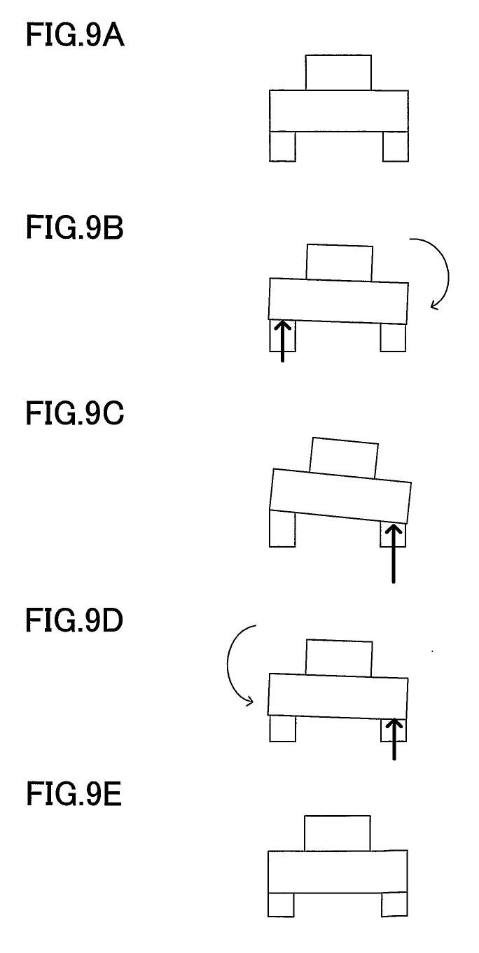

Accordingly, when the vehicle enters a straight traveling state in the middle of the turning transition, vibrations of the sprung portion (the vehicle body) cannot be suppressed or damped in some cases. In such a case, as shown in FIG. 8, the actual pitch angle θ may become less than “0”; i.e., overshoot in the negative direction (the direction of rearward tilting).

Therefore, in step S102, the suspension ECU 21 determines the demanded damping forces Fi and Fo or the changeover step numbers Ni and No of the front-wheel-side left and right shock absorbers 11 and 12 and the rear-wheel-side left and right shock absorbers 13 and 14 such that they become equal to each other. At that time, preferably, the demanded damping forces Fi and Fo or the changeover step numbers Ni and No are determined to generate a slightly large damping force. The suspension ECU 21 then maintains the determined demanded damping forces Fi and Fo or changeover step numbers Ni and No for a predetermined time (e.g., about a few tenths of second). Specifically, the suspension ECU 21 drives and controls the rotary valves 11a, 12a, 13a, and 14a via the drive circuits 23, 24, 25, and 26 such that the determined demanded damping forces Fi and Fo or changeover step numbers Ni and No are attained, and maintains this drive control state for a predetermined time.

Thus, even when the vehicle enters a straight traveling state in the middle of a turning tradition, the shock absorbers 11, 12, 13, and 14 can generate proper damping forces, to thereby effectively damp vibrations of the sprung portion (the vehicle body). Therefore, occurrence of the above-described overshoot of the actual pitch angle θ can be prevented effectively. After completion of the processing of step S102, the suspension ECU 21 proceeds to step S105.

Meanwhile, when the first rotation-operation judgment condition is not satisfied in the above-described step S101, the suspension ECU 21 proceeds to step S103. In step S103, the suspension ECU 21 determines whether or not a second rotation-operation judgment condition is satisfied. This determination processing will be described below.

This second rotation-operation judgment condition is a condition for judging that the vehicle in a turning state enters a straight traveling state (hereinafter this transition will be referred to as “turning termination”). As described above, the vehicle enters a straight traveling state or a turning state in accordance with the rotation operation of the steering wheel by the driver. Therefore, when vehicle terminates the turning, the driver stops the rotation operation of the steering wheel at the neutral position. Accordingly, when vehicle terminates the turning, the state of the rotation operation of the steering wheel is such that the absolute value of the steering angle S is small, and the steering angle velocity S′, which is obtained by differentiating the steering angle S with time, becomes relatively small.

In view of the above, the second rotation-operation judgment condition is determined such that the detected steering angle S is not greater than the previously set reference steering angle Sb, and the steering angle velocity S′ is less than the previously set reference steering angle velocity S′b. In order to perform a determination as to whether or not the second rotation-operation judgment condition is satisfied, the suspension ECU 21 receives the steering angle S detected by the steering angle sensor 27, and calculates the steering angle velocity S′ by differentiating the steering angle S with time. When the detected steering angle S and the steering angle velocity S′ satisfy the second rotation-operation judgment condition, the result of the determination in step S103 becomes “Yes,” and the suspension ECU 21 proceeds to step S104.

Meanwhile, when the detected steering angle S and the steering angle velocity S′ do not satisfy the second rotation-operation judgment condition, the result of the determination in step S103 becomes “No,” and the suspension ECU 21 proceeds to step S105 and execute the damping force control as having been described in the first embodiment or the second embodiment. That is, in this case, since the steering wheel is not rotated by the driver near the neutral position, the suspension ECU 21 controls the damping forces of the shock absorbers on the turn-locus inner side and outer side in order to control the roll generated as a result of the turning of the vehicle.

In step S104, the suspension ECU 21 equalizes the demanded damping forces Fi and Fo or the changeover step numbers Ni and No of the front-wheel-side left and right shock absorbers 11 and 12 and the rear-wheel-side left and right shock absorbers 13 and 14, and maintains the equalized damping forces Fi and Fo or the equalized changeover step numbers Ni and No for a predetermined time. Specifically, a state where the second rotation-operation judgment condition is satisfied in the above-described step S103 is a state where the vehicle enters a straight traveling condition as a result of the turning termination. In this state, the actual roll angle φ generated in the vehicle body due to the turn converges to “0.”

Meanwhile, in a state in which the second rotation-operation judgment condition is satisfied and the vehicle travels straight, no lateral acceleration is generated, so that the lateral acceleration G detected by the lateral acceleration sensor 22 becomes “0.” Therefore, when the demanded damping forces Fi and Fo or the changeover step numbers Ni and No are determined in accordance with the lateral acceleration G as having been described in the first and second embodiments, the damping forces generated by the shock absorbers 11, 12, 13, and 14 become extremely small.

In this case, when the vehicle enters a straight traveling state as a result of the turning termination, a delay may be generated in convergence of the roll of the sprung portion (the vehicle body) because an inertia acts on the vehicle body in the roll direction. Therefore, in step S104, the suspension ECU 21 determines the demanded damping forces Fi and Fo or the changeover step numbers Ni and No of the front-wheel-side left and right shock absorbers 11 and 12 and the rear-wheel-side left and right shock absorbers 13 and 14 such that they become equal to each other. At that time, preferably, the demanded damping forces Fi and Fo or the changeover step numbers Ni and No are determined to generate a slightly large damping force.

The suspension ECU 21 then maintains the determined demanded damping forces Fi and Fo or changeover step numbers Ni and No for a predetermined time (e.g., about a few tenths of second). Specifically, the suspension ECU 21 drives and controls the rotary valves 11a, 12a, 13a, and 14a via the drive circuits 23, 24, 25, and 26 such that the determined demanded damping forces Fi and Fo or changeover step numbers Ni and No are attained, and maintains this drive control state for a predetermined time.

Thus, even when the vehicle enters a straight traveling state as a result of the turning termination, the shock absorbers 11, 12, 13, and 14 can generate proper damping forces, to thereby effectively converge the roll of the sprung portion (the vehicle body). Therefore, the above-mentioned delay in roll convergence can be prevented effectively. After completion of the processing of step S104, the suspension ECU 21 proceeds to step S106, and ends the current execution of the posture control program.

In step S105, in the same manner as in the first embodiment (or the second embodiment), the suspension ECU 21 determines the demanded damping forces Fi and Fo or the changeover step numbers Ni and No of the shock absorbers 11, 12, 13, and 14 in accordance with the lateral acceleration G generated in the vehicle, and executes the damping force control. Notably, since the processing is the same as those in the first embodiment or the second embodiment, its description will be omitted.

After execution of the damping force control in step S105, the suspension ECU 21 ends the current execution of the posture control program in step S106. After elapse of a predetermined short time, the suspension ECU 21 starts again the execution of the posture control program.

As can be understood from the above description, according to this third embodiment, the shock absorbers on the turn-locus inner side and outer side can be temporarily maintained at the equalized damping forces Fi and Fo or the equalized changeover step numbers Ni and No at the time of turning transition or turning termination. This control effectively suppresses a roll back of the vehicle body which occurs at the time of turning transition or turning termination, to thereby secure a satisfactory vibration damping performance.

Thus, a roll back of the vehicle body which occurs due to an effect of inertia can be suppressed effectively, and the posture changing behavior of the vehicle during a turn can be prevented from becoming instable. Accordingly, the roll behavior can be controlled well.

Further, the turning transition of the vehicle is determined on the basis of the first rotation-operation judgment condition, and the turning termination of the vehicle is determined on the basis of the second rotation-operation judgment condition. Therefore, a fast roll behavior and a slow roll behavior, which depend on the effect of inertia, can be judged properly. That is, at the time of the turning transition, a fast roll behavior occurs because the inertia acting on the vehicle becomes the maximum. Meanwhile, at the time of the turning termination, a slow (delayed) roll behavior occurs due to the effect of the inertia. As described above, the occurred roll behavior changes in accordance with a change in the motion state of the vehicle. Therefore, the posture changing behavior can be effectively prevented from becoming instable by properly determining a change in the motion state and determining the damping forces Fi and Fo or the equalized changeover step numbers Ni and No of the shock absorbers.

The present invention is not limited to the above-described embodiments, and the embodiments may be modified in various ways without departing from the scope of the present invention.

In the above-described embodiments, the suspension ECU 21 determines the demanded damping forces Fi and Fo or the changeover step numbers Ni and No of the shock absorbers 11, 12, 13, and 14 in accordance with the lateral acceleration G detected by the lateral acceleration sensor 22, and controls the damping forces. However, the embodiments may be modified such that the suspension ECU 21 determines the damping forces Fi and Fo or the changeover step numbers Ni and No of the shock absorbers 11, 12, 13, and 14 in accordance with a yaw rate generated in the vehicle, and controls the damping forces. In this case, preferably, there is provided a yaw rate sensor which detects a generated yaw rate, and outputs the detected yaw rate to the suspension ECU 21. Notably, preferably, the yaw rate sensor is configured such that the output yaw rate assumes a positive value when the vehicle makes a leftward turn, and assumes a negative value when the vehicle makes a rightward turn.

In the case where the yaw rate generated in the vehicle is used as described above, the suspension ECU 21 calculates the distribution amount X by use of a variable α, which is proportional to the magnitude of the absolute value of the yaw rate. The suspension ECU 21 then calculates the demanded damping force Fi of the shock absorbers on the turn-locus inner side and the demanded damping force Fo of the shock absorbers on the turn-locus outer side. Thus, effects similar to those attained in the first embodiment can be attained. Further, when the suspension ECU 21 calculates the changeover step numbers Ni and No in accordance with the magnitude of the absolute value of the yaw rate, effects similar to those attained in the second embodiment can be attained.

Further, the embodiments may be modified such that the suspension ECU 21 determines the damping forces Fi and Fo or the changeover step numbers Ni and No of the shock absorbers 11, 12, 13, and 14 in accordance with the magnitude of the steering angle, which serves as the rotation operation amount of the steering wheel operated by the driver. In this case, preferably, there is provided a steering angle sensor which detects the steering angle, which changes in accordance with the rotation operation of the steering wheel by the driver, and outputs the detected steering angle to the suspension ECU 21. Notably, preferably, the steering angle sensor is configured such that the output steering angle assumes a positive value when the steering wheel is rotated in the counterclockwise direction so as to turn the vehicle leftward, and assumes a negative value when the steering wheel is rotated in the clockwise direction so as to turn the vehicle rightward.

In the case where the steering angle of the steering wheel is used as described above, the suspension ECU 21 calculates the distribution amount X by use of a variable α, which is proportional to the magnitude of the absolute value of the steering angle. The suspension ECU 21 then calculates the demanded damping force Fi of the shock absorbers on the turn-locus inner side and the demanded damping force Fo of the shock absorbers on the turn-locus outer side. Thus, effects similar to those attained in the first embodiment can be attained. Further, when the suspension ECU 21 calculates the changeover step numbers Ni and No in accordance with the magnitude of the absolute value of the steering angle, effects similar to those attained in the second embodiment can be attained.

In the third embodiment, the suspension ECU 21 determines the turning transition and the turning termination on the basis of the first rotation-operation judgment condition and the second rotation-operation determination using the steering angle S of the steering wheel and the steering angle velocity S′. The third embodiment may be modified such that the suspension ECU 21 determines the turning transition and the turning termination on the basis of the first rotation-operation judgment condition and the second rotation-operation determination using the magnitude and acting direction of lateral acceleration. Alternatively, the third embodiment may be modified such that the suspension ECU 21 determines the turning transition and the turning termination on the basis of the first rotation-operation judgment condition and the second rotation-operation determination using the magnitude and acting direction of yaw rate.

In this case, preferably, the suspension ECU 21 determines the turning transition; i.e., determines that the first rotation-operation judgment condition is satisfied, when the magnitude (the absolute value) of the lateral acceleration or the yaw rate starts to increase after has decreased, and its polarity changes. Meanwhile, the suspension ECU 21 determines the turning termination; i.e., determines that the second rotation-operation judgment condition is satisfied, when the magnitude (the absolute value) of the lateral acceleration or the yaw rate is maintained at “0.” When this modification is practiced with the first rotation-operation judgment condition and the second rotation-operation judgment condition being set in the above-described manner, effects similar to those attained in the third embodiment can be expected.

1. A damping force control apparatus for a vehicle which changes and controls damping forces of shock absorbers disposed between a vehicle body and wheels, comprising:
physical quantity detection means for detecting a predetermined physical quantity which changes with turning of the vehicle;
damping-force determination means for determining damping forces of shock absorbers disposed on a turn-locus inner side and damping forces of shock absorbers disposed on a turn-locus outer side in accordance with the detected predetermined physical quantity such that the damping forces of the shock absorbers disposed on the turn-locus inner side become greater than the damping forces of the shock absorbers disposed on the turn-locus outer side; and
damping-force control means for changing and controlling the damping forces of the shock absorbers on the basis of the determined damping forces of the shock absorbers disposed on the turn-locus inner side and the determined damping forces of the shock absorbers disposed on the turn-locus outer side.

2. A damping force control apparatus for a vehicle according to claim 1, wherein the damping-force determination means comprises:
total-damping-force calculation means for calculating a total damping force which must be cooperatively generated by left and right shock absorbers disposed on the front-wheel side of the vehicle and left and right shock absorbers disposed on the rear-wheel side of the vehicle so as to control a roll generated in the vehicle body as a result of turning of the vehicle; and
total-damping-force distribution means for distributing the calculated total damping force to the shock absorbers disposed on the turn-locus inner side and the shock absorbers disposed on the turn-locus outer side in accordance with the detected predetermined physical quantity such that the damping forces of the shock absorbers disposed on the turn-locus inner side become greater than the damping forces of the shock absorbers disposed on the turn-locus outer side.

3. A damping force control apparatus for a vehicle according to claim 2, wherein the total-damping-force distribution means distributes the calculated total damping force in proportion to the detected predetermined physical quantity such that the damping forces of the shock absorbers disposed on the turn-locus inner side become greater than the damping forces of the shock absorbers disposed on the turn-locus outer side.

4. A damping force control apparatus for a vehicle according to claim 3, wherein the total-damping-force distribution means equally distributes the calculated total damping force to the shock absorbers disposed on the turn-locus inner side and the shock absorbers disposed on the turn-locus outer side, adds a damping force distribution amount, which is proportional to the detected predetermined physical quantity, to the damping force distributed to the shock absorbers disposed on the turn-locus inner side, and subtracts the damping force distribution amount from the damping force distributed to the shock absorbers disposed on the turn-locus outer side, such that that the damping forces of the shock absorbers disposed on the turn-locus inner side become greater than the damping forces of the shock absorbers disposed on the turn-locus outer side.

5. A damping force control apparatus for a vehicle according to claim 2, wherein
the damping forces of the left and right shock absorbers disposed on the front-wheel side and the rear-wheel side, respectively, are changed stepwise among a plurality of changeover steps each of which is designated by a changeover step number and which have a predetermined change amount between adjacent steps; and
the total-damping-force distribution means distributes the calculated total damping force to the shock absorbers disposed on the turn-locus inner side and the shock absorbers disposed on the turn-locus outer side in accordance with the detected predetermined physical quantity, by designating a changeover step number for each of the shock absorbers, such that the damping forces of the shock absorbers disposed on the turn-locus inner side become greater than the damping forces of the shock absorbers disposed on the turn-locus outer side.

6. A damping force control apparatus for a vehicle according to claim 5, wherein the change amount of damping force between adjacent changeover steps determined for the shock absorbers disposed on the turn-locus inner side is large in relation to a change in the detected predetermined physical quantity, and the change amount of damping force between adjacent changeover steps determined for the shock absorbers disposed on the turn-locus outer side is small in relation to a change in the detected predetermined physical quantity.

7. A damping force control apparatus for a vehicle according to claim 5, wherein the changeover step number is determined linearly or non-linearly in relation to a change in the detected predetermined physical quantity.

8. A damping force control apparatus for a vehicle according to claim 1, further comprising:
motion state judging means for judging a reverse of the turning direction of the vehicle or a transition of the vehicle from a turning state to a straight traveling state on the basis of the detected predetermined physical quantity; and
damping-force holding means for holding the damping forces of the shock absorbers disposed on the turn-locus inner side and the damping forces of the shock absorbers disposed on the turn-locus outer side at respective predetermined levels for a predetermined time, when the motion state judging means judges a reverse of the turning direction of the vehicle or a transition of the vehicle from a turning state to a straight traveling state.

9. A damping force control apparatus for a vehicle according to claim 8, wherein the motion state judging means determines changes in the motion state of the vehicle on the basis of a first judgment condition which relates to a change in the predetermined physical quantity and which is previously set in order to judge a reverse of the turning direction of the vehicle, and a second judgment condition which relates to a change in the predetermined physical quantity and which is previously set in order to judge a transition of the vehicle from a turning state to a straight traveling state.

10. A damping force control apparatus for a vehicle according to claim 8, wherein the damping-force holding means holds the damping forces of the shock absorbers disposed on the turn-locus inner side and the damping forces of the shock absorbers disposed on the turn-locus outer side at the same level for the predetermined time, when the motion state judging means judges a reverse of the turning direction of the vehicle or a transition of the vehicle from a turning state to a straight traveling state.

11. A damping force control apparatus for a vehicle according to claim 8, wherein
the damping forces of the shock absorbers disposed on the turn-locus inner side and the damping forces of the shock absorbers disposed on the turn-locus outer side are changed stepwise among a plurality of changeover steps each of which is designated by a changeover step number and which have a predetermined change amount between adjacent steps; and
the damping-force holding means holds, for the predetermined time, the damping forces of the shock absorbers disposed on the turn-locus inner side and the damping forces of the shock absorbers disposed on the turn-locus outer side at the same level by designating the same changeover step number for the shock absorbers disposed on the turn-locus inner side and outer side, respectively, when the motion state judging means judges a reverse of the turning direction of the vehicle or a transition of the vehicle from a turning state to a straight traveling state.

12. A damping force control apparatus for a vehicle according to claim 1, wherein the predetermined physical quantity detected by the physical quantity detection means is at least one of a lateral acceleration generated as a result of turning of the vehicle, a yaw rate generated as a result of turning of the vehicle, and an operation amount of a steering wheel operated by a driver.

13. A damping force control apparatus for a vehicle according to claim 1, wherein each shock absorber includes an electrical actuator which is electrically operated and controlled so as to change the damping force of the shock absorber, and the damping force control means electrically operates and controls the electrical actuators of the shock absorbers such that the damping forces of the shock absorbers disposed on the turn-locus inner side become greater than the damping forces of the shock absorbers disposed on the turn-locus outer side.

14. A damping force control apparatus for a vehicle according to claim 2, wherein the total-damping-force calculation means
computes an actual roll angle and an actual pitch angle generated in the vehicle body,
determines a target pitch angle corresponding to the computed actual roll angle on the basis of a previously set correlation between roll angle and pitch angle,
computes a difference between the determined target pitch angle and the computed actual pitch angle, and
calculates the total damping force such that the computed difference become about zero, in order to control the roll generated in the vehicle body while synchronizing the phases of the actual roll angle and the actual pitch angle.

15. A damping force control apparatus for a vehicle according to claim 9, wherein
the first judgment condition is that an operation amount of a steering wheel operated by a driver is not greater than a previously set reference operation amount and an operation speed of the steering wheel is not less than a previously set reference operation speed; and
the second judgment condition is that the operation amount of the steering wheel is not greater than the previously set reference operation amount and the operation speed of the steering wheel is less than the previously set reference operation speed.

16. A damping force control apparatus for a vehicle according to claim 6, wherein
when the absolute value of the detected predetermined physical quantity is small, the maximum changeover step number is set for the shock absorbers disposed on the turn-locus inner side such that the damping forces of the shock absorbers disposed on the turn-locus inner side becomes the maximum; and
when the absolute value of the detected predetermined physical quantity is larger than the absolute value of the detected predetermined physical quantity at which the maximum changeover step number is set for the shock absorbers disposed on the turn-locus inner side, the maximum changeover step number is set for the shock absorbers disposed on the turn-locus outer side such that the damping forces of the shock absorbers disposed on the turn-locus outer side becomes the maximum.
